(19) United States
(12) Patent Application Publication
(10) Pub. No.: US 2024/0176669 A1
(43) Pub. Date: May 30, 2024

(54) RESOURCE SCHEDULING METHODS AND APPARATUSES, AND ELECTRONIC DEVICES

(71) Applicant: Alipay (Hangzhou) Information Technology Co., Ltd., Hangzhou (CN)

(72) Inventors: Wei WU, Hangzhou (CN); Denghui LI, Hangzhou (CN); Tongkai YANG, Hangzhou (CN)

(21) Appl. No.: 18/517,587

(22) Filed: Nov. 22, 2023

(30) Foreign Application Priority Data
Nov. 25, 2022 (CN) 202211490807.9

(51) Int. Cl. G06F 9/50; G06F 9/48

(52) U.S. Cl. CPC G06F 9/5038; G06F 9/4881

(57) ABSTRACT

This specification discloses resource scheduling methods and apparatuses, electronic devices. The resource scheduling method includes following: estimated resource consumption data of a target container group in a plurality of time periods is determined in response to a resource application request of the target container group, resource amount data of each of a plurality of cluster nodes in the plurality of time periods is obtained, and the target container group is scheduled to at least one of the plurality of cluster nodes based on the estimated resource consumption data and the resource amount data. It can be seen that in this specification, different resource amounts can be allocated to the target container group in different time periods, and the target container group can fully use resources allocated to the target container group in each time period during running, thereby reducing the waste of cluster resources.

### TECHNICAL FIELD

This specification relates to the field of resource processing technologies, and specifically, to resource scheduling methods and apparatuses, and electronic devices.

### BACKGROUND

A cluster is a computer system in which a group of loosely integrated computer software and/or hardware is connected to complete computing work in cooperation. A single computer in a cluster system is referred to as a cluster node, and a plurality of cluster nodes are connected by using a network. A resource scheduling system is a system configured to allocate a container group (Pod) to a cluster node. The resource scheduling system usually allocates a cluster node based on a resource amount requested by a Pod, and the Pod usually applies for a needed resource amount based on peak resources used during running.

However, the resource amount used by the Pod during running is usually less than the peak resources. As a result, the Pod cannot fully use the applied resource amount during running, causing the waste of cluster resources.

### SUMMARY

In view of this, this specification provides resource scheduling methods and apparatuses, and electronic devices.

According to a first aspect, a resource scheduling method is provided. The resource scheduling method includes following: Estimated resource consumption data of a target container group in a plurality of time periods is determined in response to a resource application request of the target container group; resource amount data of each of a plurality of cluster nodes in the plurality of time periods is obtained, where the resource amount data can represent a resource headroom of the cluster node; and the target container group is scheduled to at least one of the plurality of cluster nodes based on the estimated resource consumption data of the target container group in the plurality of time periods and the resource amount data of each of the plurality of cluster nodes in the plurality of time periods.

According to a second aspect, a resource scheduling apparatus is provided, and the resource scheduling apparatus includes a determining module, an acquisition module, and a scheduling module. The determining module is configured to determine estimated resource consumption data of a target container group in a plurality of time periods in response to a resource application request of the target container group; the acquisition module is configured to obtain resource amount data of each of a plurality of cluster nodes in the plurality of time periods, where the resource amount data can represent a resource headroom of the cluster node; and the scheduling module is configured to schedule the target container group to at least one of the plurality of cluster nodes based on the estimated resource consumption data of the target container group in the plurality of time periods and the resource amount data of each of the plurality of cluster nodes in the plurality of time periods.

According to a third aspect, a computer-readable storage medium is provided. The storage medium stores instructions, and when the instructions are executed, the resource scheduling method mentioned in the first aspect can be implemented.

According to a fourth aspect, a computer program product is provided, including instructions. When the instructions are executed, the resource scheduling method mentioned in the first aspect can be implemented.

According to a fifth aspect, an electronic device is provided. The electronic device includes a memory and a processor. The memory stores executable code, and the processor is configured to execute the executable code to implement the resource scheduling method mentioned in the first aspect.

According to the resource scheduling method provided in embodiments of this specification, first, the estimated resource consumption data of the target container group in the plurality of time periods is determined in response to the resource application request of the target container group. Then, the resource amount data of each of the plurality of cluster nodes in the plurality of time periods is obtained. Finally, the target container group is scheduled to at least one of the plurality of cluster nodes based on the estimated resource consumption data of the target container group in the plurality of time periods and the resource amount data of each of the plurality of cluster nodes in the plurality of time periods. In other words, in this specification, the cluster node is allocated based on the estimated resource consumption data of the target container group in the plurality of time periods, so that different resource amounts can be allocated to the target container group in different time periods, and the target container group can fully use resources allocated to the target container group in cach time period during running, thereby reducing the waste of cluster resources.

### BRIEF DESCRIPTION OF DRAWINGS

FIG. 1a is a schematic diagram illustrating resource usage of Pod A, according to one or more embodiments of this specification;

FIG. 1b is a schematic diagram illustrating resource usage of Pod B, according to one or more embodiments of this specification;

FIG. 2 is a schematic diagram illustrating allocating resources based on peak resource usage, according to one or more embodiments of this specification;

FIG. 3 is a schematic diagram illustrating a resource scheduling method, according to one or more embodiments of this specification;

FIG. 4 is a schematic diagram illustrating an application scenario of a resource scheduling method, according to one or more embodiments of this specification;

FIG. 5 is a schematic diagram illustrating an application scenario of a resource scheduling method, according to other embodiments of this specification;

FIG. 6 is a schematic flowchart illustrating a resource scheduling method, according to one or more embodiments of this specification;

FIG. 7 is a schematic flowchart illustrating a resource scheduling method, according to one or more embodiments of this specification;

FIG. 8 is a schematic flowchart illustrating a resource scheduling method, according to one or more embodiments of this specification;

FIG. 9 is a schematic flowchart illustrating a resource scheduling method, according to one or more embodiments of this specification;

FIG. 10 is a schematic flowchart illustrating a resource scheduling method, according to one or more embodiments of this specification;

FIG. 11 is a schematic flowchart illustrating a resource scheduling method, according to one or more embodiments of this specification;

FIG. 12 is a schematic flowchart illustrating a resource scheduling method, according to one or more embodiments of this specification;

FIG. 13 is a schematic diagram illustrating a structure of a resource scheduling apparatus, according to one or more embodiments of this specification; and

FIG. 14 is a schematic diagram illustrating a structure of an electronic device, according to one or more embodiments of this specification.

### DESCRIPTION OF EMBODIMENTS

The following clearly and comprehensively describes the technical solutions in embodiments of this specification with reference to the accompanying drawings in the embodiments of this specification. Clearly, the described embodiments are merely some rather than all of the embodiments of this specification.

A cluster is a computer system in which a group of loosely integrated computer software and/or hardware is connected to complete computing work in cooperation. A single computer in a cluster system is referred to as a cluster node, and a plurality of cluster nodes are connected by using a network. A resource scheduling system is a system configured to allocate a container group (Pod) to a cluster node. The resource scheduling system usually allocates a cluster node based on a resource amount requested by a Pod, and the Pod usually applies for a needed resource amount based on peak resources used during running. However, the resource amount used by the Pod during running is usually less than the peak resources. As a result, the Pod cannot fully use the applied resource amount during running, causing the waste of cluster resources.

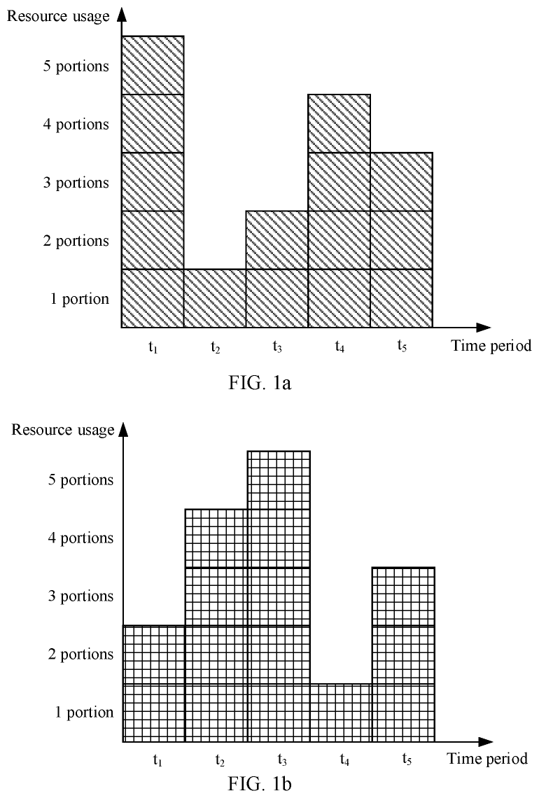

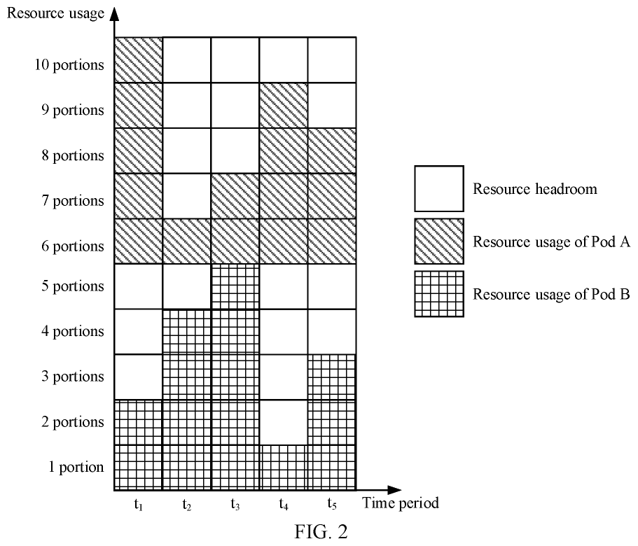

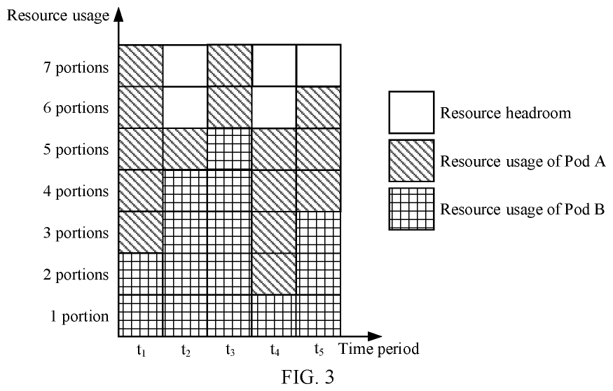

For example, as shown in FIG. 1a, in five time periods from t₁ to t₅, resource usage of Pod A is respectively 5 portions, 1 portion, 2 portions, 4 portions, and 3 portions. As shown in FIG. 1b, in the five time periods from t₁ to t₅, resource usage of Pod B is respectively 2 portions, 4 portions, 5 portions, 1 portion, and 3 portions. In other words, peak resource usage of Pod A during running is 5 portions, and peak resource usage of Pod B during running is also 5 portions. As shown in FIG. 2, if resources are allocated based on the peak resource usage to schedule Pod A and Pod B to one cluster node, Pod A and Pod B can be allocated to the cluster node only when the cluster node has 10 portions of resources. As shown in FIG. 3, if resources are allocated based on the resource scheduling method in this specification to schedule Pod A and Pod B to one cluster node, Pod A and Pod B can be allocated to the cluster node provided that the cluster node has 7 portions of resources. In other words, in this specification, the cluster node is allocated based on estimated resource consumption data (that is, the previous resource usage) of the Pod in a plurality of time periods, so that different resource amounts can be allocated to the Pod in different time periods, and the Pod can fully use resources allocated to the Pod in each time period during running, thereby reducing the waste of cluster resources.

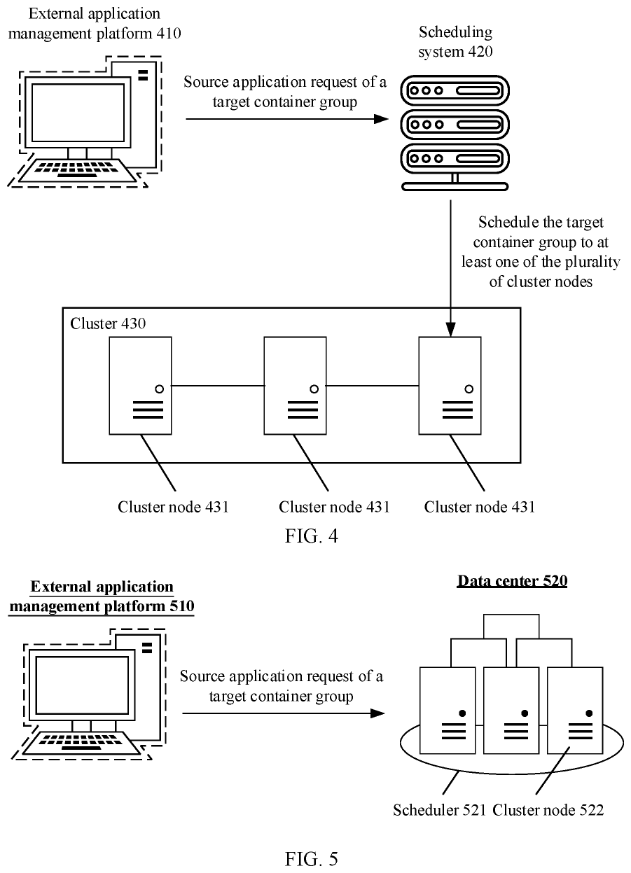

The following describes application scenarios by using examples with reference to FIG. 4 and FIG. 5.

FIG. 4 is a schematic diagram illustrating an application scenario of a resource scheduling method, according to one or more embodiments of this specification. As shown in FIG. 4, the application scenario in this implementation includes an external application management platform 410, a scheduling system 420, and a cluster 430. The cluster 430 includes a plurality of cluster nodes 431. The external application management platform 410 is configured to send a resource application request of a target container group to the scheduling system 420. The scheduling system 420 determines estimated resource consumption data of the target container group in a plurality of time periods in response to the resource application request of the target container group, obtains resource amount data of each of the plurality of cluster nodes 431 in the plurality of time periods, and schedules the target container group to at least one of the plurality of cluster nodes 431 based on the estimated resource consumption data of the target container group in the plurality of time periods and the resource amount data of each of the plurality of cluster nodes in the plurality of time periods.

In some implementations, the external application management platform 410 can be a software system installed on a computer, a server, or a cloud. The scheduling system 420 can be a software system installed on a computer, a server, or a cloud. The cluster 430 is a computer system in which a group of loosely integrated computer software (and/or) hardware is connected to complete computing work in cooperation. A single computer in the cluster 430 is the cluster node 431, and the plurality of cluster nodes 431 are connected by using a network.

FIG. 5 is a schematic diagram illustrating an application scenario of a resource scheduling method, according to one or more embodiments of this specification. As shown in FIG. 5, the application scenario in this implementation includes an external application management platform 510 and a data center 520. The data center 520 includes a scheduler 521 and a plurality of cluster nodes 522. The external application management platform 510 is configured to send a resource application request of a target container group to the data center 520. The scheduler 521 in the data center 520 is configured to perform the resource scheduling method in this specification, to schedule the target container group to one of the plurality of cluster nodes 522.

In some implementations, the external application management platform 510 can be a software system installed on a computer, a server, or a cloud. The data center 520 is a globally coordinated specific device network, and is configured to transfer, accelerate, display, compute, and store data information on a network infrastructure. The scheduler 521 can be software responsible for allocating resources in the data center 520. The cluster node 522 is a single computer in a computer cluster, and the plurality of cluster nodes 522 are connected by using a network.

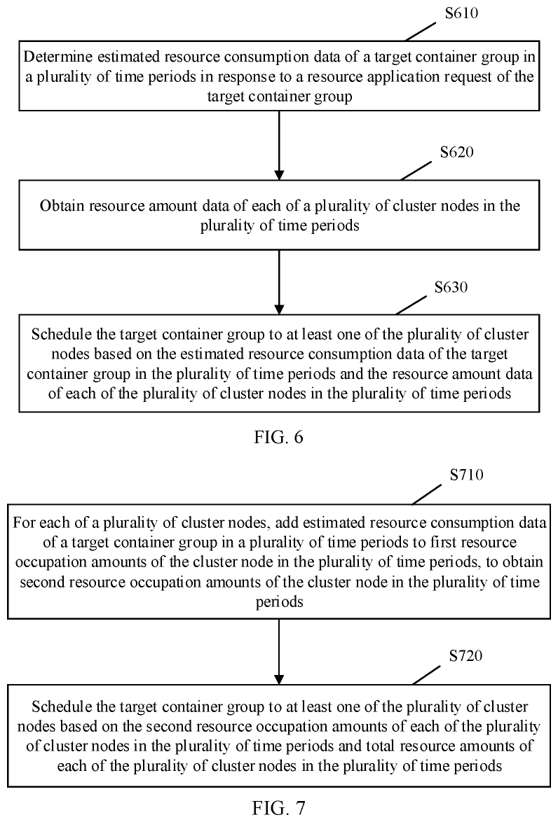

The following describes the resource scheduling method by using an example with reference to FIG. 6.

FIG. 6 is a schematic flowchart illustrating a resource scheduling method, according to one or more embodiments of this specification. Specifically, this implementation is applied to a resource scheduling system. As shown in FIG. 6, the resource scheduling method provided in this implementation includes the following steps.

Step S610: Determine estimated resource consumption data of a target container group in a plurality of time periods in response to a resource application request of the target container group.

Specifically, the target container group includes at least one application container. The application container is an interface used to store and organize applications. The application container isolates the applications during running of the applications through kernel isolation and resource limitation. The resource application request of the target container group can be a resource application request sent by an external application management platform to the resource scheduling system. Specifically, the resource application request of the target container group can be requesting resources of a fixed specification, for example, 4C8G100G, where 4C8G100G indicates that the target container group applies for four CPU cores, an 8 GB memory, and 100 GB disk resources. The estimated resource consumption data can be a resource amount that needs to be consumed during running of the target container group. The estimated resource consumption data of the target container group in the plurality of time periods can be obtained through statistics collection based on a historical resource consumption status of the target container group. The historical resource consumption status of the target container group can be obtained by the resource scheduling system from a system for storing an application profile. The application profile is description of traffic and resource usage features of an application during running of the application.

The plurality of time periods can be a plurality of time periods in a day, a plurality of time periods in a week, or a plurality of time periods in a month. A length of the time period can be selected based on a specific application scenario. For example, one day has 24 hours. If every four hours is one time period, one day can be divided into the following six time periods: 0 o'clock to 4 o'clock. 4 o'clock to 8 o'clock, 8 o'clock to 12 o'clock, 12 o'clock to 16 o'clock, 16 o'clock to 20 o'clock, and 20 o'clock to 24 o'clock. The estimated resource consumption data of the target container group in the six time periods can be respectively 5 MB. 15 MB, 8 MB, 3 MB, 10 MB, and 12 MB. In other words, in actual applications, resources consumed for running by the target container group in different time periods may be different.

For example, after the estimated resource consumption data of the target container group in the plurality of time periods is determined, the estimated resource consumption data of the target container group in the plurality of time periods can be injected (or stored) into the target container group. Specifically, the estimated resource consumption data of the target container group in the plurality of time periods can be stored in the following format: [{time_range 1, resource_amount 1}, {time_range 2, resource_amount 2} . . . . {time_range n, resource_amount n} ]. For example, the stored estimated resource consumption data of the target container group in the plurality of time periods can be [{time_0-6, resource_5G}, {time_6-12, resource_8G}, {time_12-18, resource_4G}, {time_18-24, resource_6G}].

In some implementations, the at least one application container includes a plurality of application containers. Peaks and valleys of the estimated resource consumption data of the plurality of application containers in the plurality of time periods are complementary to each other. For example, the plurality of application containers can include application container A and application container B. If a peak value appears in the estimated resource consumption data of application container A in a first time period (that is, the estimated resource consumption data in the first time period is larger than the estimated resource consumption data in other time periods), a valley value appears in the estimated resource consumption data of application container B in the first time period (that is, the estimated resource consumption data in the first time period is smaller than the estimated resource consumption data in other time periods). Correspondingly, if a valley value appears in the estimated resource consumption data of application container A in a second time period (that is, the estimated resource consumption data in the second time period is smaller than the estimated resource consumption data in other time periods), a peak value appears in the estimated resource consumption data of application container B in the second time period (that is, the estimated resource consumption data in the second time period is larger than the estimated resource consumption data in other time periods). In this setting, cluster resources can be fully used in each time period, thereby further saving cluster resources.

Step S620: Obtain resource amount data of each of a plurality of cluster nodes in the plurality of time periods.

Specifically, the resource amount data can represent a resource headroom of the cluster node. The resource amount data can be a resource occupation amount and a total resource amount. The resource amount data can alternatively be a resource headroom. The resource headroom can be obtained by calculating a difference between the total resource amount and the resource occupation amount, or can be resource headrooms of each of the plurality of cluster nodes in the plurality of time periods that are directly obtained by the resource scheduling system.

For example, estimated resource consumption data of a target container group in four time periods (0 o'clock to 6 o'clock, 6 o'clock to 12 o'clock, 12 o'clock to 18 o'clock, and 18 o'clock to 24 o'clock) is respectively 5 MB, 15 MB, 8 MB, and 12 MB. After the target container group is scheduled to a cluster node whose resources are unoccupied, resource occupation amounts of the cluster node in the four time periods is respectively 5 MB, 15 MB, 8 MB and 12 MB. If a total resource amount of the cluster node is 100 MB, resource headrooms of the cluster node in the four time periods are respectively 95 MB, 85 MB, 92 MB, and 88 MB.

Step S630: Schedule the target container group to at least one of the plurality of cluster nodes based on the estimated resource consumption data of the target container group in the plurality of time periods and the resource amount data of each of the plurality of cluster nodes in the plurality of time periods.

Specifically, it may be determined whether the resource amount data of the cluster node in the plurality of time periods satisfies a need of the estimated resource consumption data of the target container group in the plurality of time periods. If the need is satisfied, the target container group can be scheduled to at least one cluster node that satisfies the need in the plurality of cluster nodes.

In this specification, the cluster node is allocated based on the estimated resource consumption data of the target container group in the plurality of time periods, so that different resource amounts can be allocated to the target container group in different time periods, and the target container group can fully use resources allocated to the target container group in each time period during running, thereby reducing the waste of cluster resources.

With reference to FIG. 7, the following uses an example to describe how to specifically schedule the target container group to at least one of the plurality of cluster nodes.

FIG. 7 is a schematic flowchart illustrating a resource scheduling method, according to other embodiments of this specification. As shown in FIG. 7, the step of scheduling the target container group to at least one of the plurality of cluster nodes based on the estimated resource consumption data of the target container group in the plurality of time periods and the resource amount data of each of the plurality of cluster nodes in the plurality of time periods includes the following steps.

Step S710: For each of the plurality of cluster nodes, add the estimated resource consumption data of the target container group in the plurality of time periods to first resource occupation amounts of the cluster node in the plurality of time periods, to obtain second resource occupation amounts of the cluster node in the plurality of time periods.

Specifically, the resource amount data includes a first resource occupation amount and a total resource amount. The total resource amount is a resource amount of the cluster node before any container group is allocated to the cluster node. The first resource occupation amount is a resource amount already occupied by the cluster node.

For example, first resource occupation amounts of the cluster node in four time periods (0 o'clock to 6 o'clock, 6 o'clock to 12 o'clock, 12 o'clock to 18 o'clock, and 18 o'clock to 24 o'clock) are respectively 5 MB, 15 MB, 8 MB, and 12 MB, and estimated resource consumption data of the target container group in the four time periods (0 o'clock to 6 o'clock, 6 o'clock to 12 o'clock, 12 o'clock to 18 o'clock, and 18 o'clock to 24 o'clock) is respectively 5 MB, 2 MB, 3 MB, and 2 MB. After the estimated resource consumption data of the target container group in the four time periods is respectively added to the first resource occupation amounts of the cluster node in the four time periods, it is learned that second resource occupation amounts of the cluster node in the four time periods are respectively 10 MB, 17 MB, 11 MB, and 14 MB.

Step S720: Schedule the target container group to at least one of the plurality of cluster nodes based on the second resource occupation amounts of each of the plurality of cluster nodes in the plurality of time periods and total resource amounts of each of the plurality of cluster nodes in the plurality of time periods.

For example, if the total resource amounts of the cluster node in the plurality of time periods are greater than the second resource occupation amounts of the cluster node in the plurality of time periods, it indicates that the cluster node satisfies a need of the target container group, and the target container group can be scheduled to the cluster node.

The second resource occupation amounts of the cluster node in the plurality of time periods are calculated, then at least one cluster node that satisfies the resource need of the target container group can be selected from the plurality of cluster nodes based on the second resource occupation amounts and the total resource amounts, and the target container group is further scheduled to the cluster node that satisfies the resource need of the target container group in the plurality of cluster nodes. A calculation method is simple, and the cluster node that satisfies the resource need of the target container group can be quickly determined.

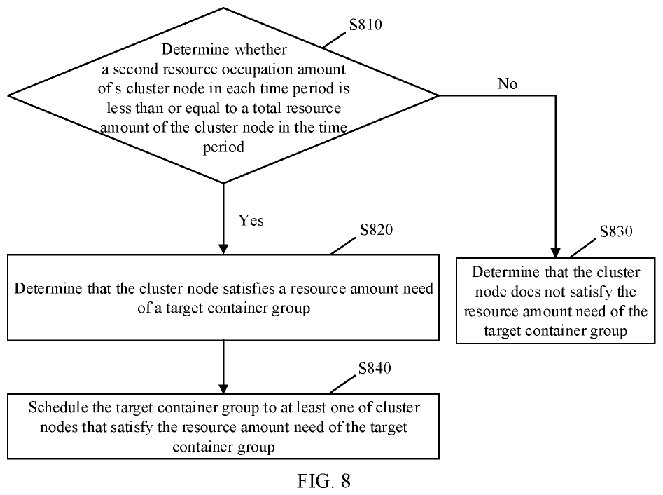

To more clearly describe how to determine the cluster node that satisfies the resource need of the target container group, the following uses an example for description with reference to FIG. 8.

FIG. 8 is a schematic flowchart illustrating a resource scheduling method, according to other embodiments of this specification. As shown in FIG. 8, the step of scheduling the target container group to at least one of the plurality of cluster nodes based on the second resource occupation amounts of each of the plurality of cluster nodes in the plurality of time periods and total resource amounts of each of the plurality of cluster nodes in the plurality of time periods includes the following steps.

Step S810: Determine whether the second resource occupation amount of the cluster node in each time period is less than or equal to the total resource amount of the cluster node in the time period.

Step S810 is performed for each of the plurality of cluster nodes.

If a determining result of step S810 is that the second resource occupation amount of the cluster node in each time period is less than or equal to the total resource amount of the cluster node in the time period, the following step S820 is performed; or if the determining result of step S810 is that not all the second resource occupation amounts of the cluster node in the time periods are less than or equal to the total resource amounts of the cluster node in the time periods, the following step S830 is performed.

Step S820: Determine that the cluster node satisfies a resource amount need of the target container group.

Step S830: Determine that the cluster node does not satisfy the resource amount need of the target container group.

Specifically, if the second resource occupation amount of the cluster node in each time period is less than or equal to the total resource amount of the cluster node in the time period, it indicates that the cluster node can provide enough resources for the target container group in each time period. Therefore, it may be determined that the cluster node satisfies the resource amount need of the target container group.

Step S840: Schedule the target container group to at least one of cluster nodes that satisfy the resource amount need of the target container group.

Specifically, a plurality of cluster nodes that satisfy the resource amount need can be determined from the plurality of cluster nodes through steps S810 and S820. For example, the plurality of cluster nodes can be 100 cluster nodes, and the at least one cluster node that satisfies the resource amount need can be 60 cluster nodes in the 100 cluster nodes.

Specifically, all of the at least one cluster node are cluster nodes that satisfy the resource amount need, and therefore, the target container group can be scheduled to the at least one cluster node or any one of the at least one cluster node.

Whether the second resource occupation amount of the cluster node in each time period is less than or equal to the total resource amount of the cluster node in the time period can be determined to determine at least one cluster node that satisfies the resource amount need, so that the target container group is scheduled to the at least one cluster node, which provides a broad data basis for subsequently selecting a cluster node with better performance from the at least one cluster node.

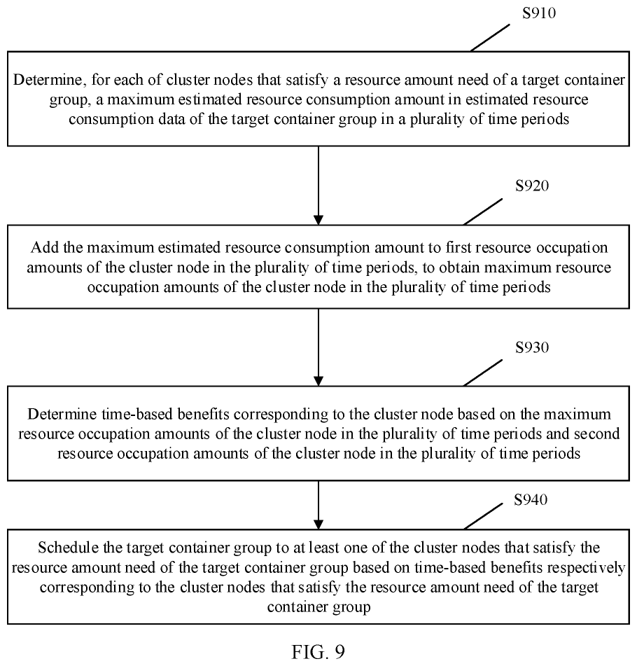

To more clearly describe how to select a better cluster node from at least one cluster node that satisfies the resource amount need, the following uses an example for description with reference to FIG. 9.

FIG. 9 is a schematic flowchart illustrating a resource scheduling method, according to other embodiments of this specification. As shown in FIG. 9, the step of scheduling the target container group to at least one of the cluster nodes that satisfy the resource amount need of the target container group includes the following steps.

Step S910: Determine, for each of the cluster nodes that satisfy the resource amount need of the target container group, a maximum estimated resource consumption amount in the estimated resource consumption data of the target container group in the plurality of time periods.

For example, the estimated resource consumption data of the target container group in four time periods (0 o'clock to 6 o'clock, 6 o'clock to 12 o'clock, 12 o'clock to 18 o'clock, and 18 o'clock to 24 o'clock) is respectively 5 MB, 2 MB, 3 MB, and 2 MB. In this case, the maximum estimated resource consumption amount in the estimated resource consumption data of the target container group in the four time periods is 5 MB.

Step S920: Add the maximum estimated resource consumption amount to the first resource occupation amounts of the cluster node in the plurality of time periods, to obtain maximum resource occupation amounts of the cluster node in the plurality of time periods.

For example, first resource occupation amounts of the cluster node in four time periods (0 o'clock to 6 o'clock, 6 o'clock to 12 o'clock, 12 o'clock to 18 o'clock, and 18 o'clock to 24 o'clock) are respectively 5 MB, 15 MB. 8 MB, and 12 MB. After the maximum estimated resource consumption amount is added to the first resource occupation amounts of the cluster node in the plurality of time periods, it is learned that maximum resource occupation amounts of the cluster node in the plurality of time periods are respectively 10 MB, 20 MB, 13 MB, and 17 MB.

Step S930: Determine time-based benefits corresponding to the cluster node based on the maximum resource occupation amounts of the cluster node in the plurality of time periods and the second resource occupation amounts of the cluster node in the plurality of time periods.

Specifically, the time-based benefit is used to represent resources saved in the second resource occupation amount relative to the maximum resource occupation amount.

For example, the time-based benefits corresponding to the cluster node can be differences between the maximum resource occupation amounts of the cluster node in the plurality of time periods and the second resource occupation amounts of the cluster node in the plurality of time periods. The maximum resource occupation amounts of the cluster node in the plurality of time periods are respectively 10 MB. 20 MB, 13 MB, and 17 MB, and the second resource occupation amounts of the cluster node in the plurality of time periods are respectively 10 MB, 17 MB, 11 MB, and 14 MB. Therefore, the time-based benefits corresponding to the cluster node in the plurality of time periods are respectively 0 MB. 3 MB, 2 MB, and 3 MB. The time-based benefit corresponding to the cluster node can be an average value of the corresponding time-based benefits in the plurality of time periods, that is, 2 MB. The time-based benefit corresponding to the cluster node can be a sum of the corresponding time-based benefits in the plurality of time periods, that is, 8 MB.

Step S940: Schedule the target container group to at least one of the cluster nodes that satisfy the resource amount need of the target container group based on time-based benefits respectively corresponding to the cluster nodes that satisfy the resource amount need of the target container group.

The scheduling the target container group to at least one of the cluster nodes that satisfy the resource amount need of the target container group based on time-based benefits respectively corresponding to the cluster nodes that satisfy the resource amount need of the target container group can be: selecting at least one cluster node with a high time-based benefit from the cluster nodes that satisfy the resource amount need of the target container group, and then scheduling the target container group to the at least one cluster node.

The time-based benefits respectively corresponding to the cluster nodes that satisfy the resource amount need of the target container group can be calculated to determine at least one cluster node with a high time-based benefit based on the time-based benefits, thereby saving more cluster resources.

In some implementations, the scheduling the target container group to at least one of the cluster nodes that satisfy the resource amount need of the target container group based on time-based benefits respectively corresponding to the cluster nodes that satisfy the resource amount need of the target container group can be: scoring the cluster nodes based on the time-based benefits respectively corresponding to the cluster nodes that satisfy the resource amount need of the target container group to determine scores respectively corresponding to the cluster nodes that satisfy the resource amount need of the target container group, and then scheduling, based on the scores, the target container group to at least one of the cluster nodes that satisfy the resource amount need of the target container group. For example, the target container group can be scheduled to a cluster node with a high score in the at least one cluster node. In actual applications, a cluster node with better performance is determined through scoring. The method is simple and reliable and has high efficiency.

In some implementations, the scheduling the target container group to at least one of the cluster nodes that satisfy the resource amount need of the target container group based on time-based benefits respectively corresponding to the cluster nodes that satisfy the resource amount need of the target container group can be: determining, based on the time-based benefits respectively corresponding to the cluster nodes that satisfy the resource amount need of the target container group, a cluster node with a maximum time-based benefit in the cluster nodes that satisfy the resource amount need of the target container group, and then scheduling the target container group to the cluster node with the maximum time-based benefit, thereby further saving cluster resources.

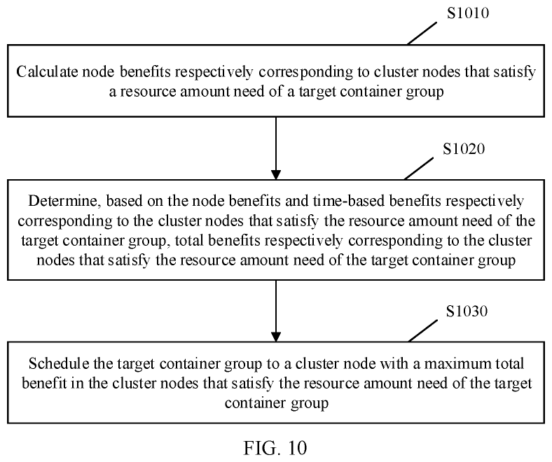

With reference to FIG. 10, the following uses an example to describe a method for selecting, with reference to the time-based benefits, a better cluster node from the cluster nodes that satisfy the resource amount need.

FIG. 10 is a schematic flowchart illustrating a resource scheduling method, according to other embodiments of this specification. As shown in FIG. 10, the step of scheduling the target container group to at least one of the cluster nodes that satisfy the resource amount need of the target container group based on time-based benefits respectively corresponding to the cluster nodes that satisfy the resource amount need of the target container group includes the following steps.

Step S1010: Calculate node benefits respectively corresponding to the cluster nodes that satisfy the resource amount need of the target container group.

Specifically, the node benefit is used to represent a resource headroom of the cluster node. A larger resource headroom of the cluster node can represent better node performance of the cluster node. For example, a resource headroom of one cluster node can be 50 MB, and a resource headroom of another cluster node can be 80 MB. If both the two cluster nodes can satisfy the resource need of the target container group, the target container group can be scheduled to the cluster node whose resource headroom is 80 MB.

Step S1020: Determine, based on the node benefits and the time-based benefits respectively corresponding to the cluster nodes that satisfy the resource amount need of the target container group, total benefits respectively corresponding to the cluster nodes that satisfy the resource amount need of the target container group.

Specifically, the total benefit corresponding to the cluster node can be a sum of the node benefit and the time-based benefit, or can be an average value of the node benefit and the time-based benefit, or can be a weighted average value of the node benefit and the time-based benefit. Weights of the node benefit and the time-based benefit can be selected based on an actual situation.

Step S1030: Schedule the target container group to a cluster node with a maximum total benefit in the cluster nodes that satisfy the resource amount need of the target container group.

For example, the target container group can be scheduled to the cluster node with the larger total benefit in the cluster nodes that satisfy the resource amount need of the target container group, or the target container group can be scheduled to the cluster node with the maximum total benefit in the cluster nodes that satisfy the resource amount need of the target container group.

The total benefits of the cluster nodes are calculated to more comprehensively consider performance of each cluster node, so that a cluster node with better performance can be selected more comprehensively.

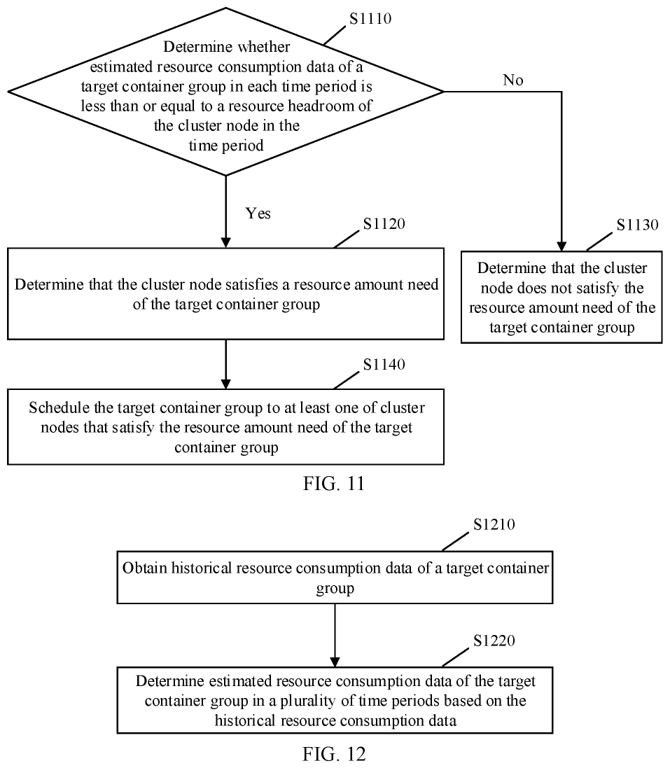

With reference to FIG. 11, the following uses an example to describe another specific implementation of scheduling the target container group to at least one of the plurality of cluster nodes.

FIG. 11 is a schematic flowchart illustrating a resource scheduling method, according to other embodiments of this specification. As shown in FIG. 11, the step of scheduling the target container group to at least one of the plurality of cluster nodes based on the estimated resource consumption data of the target container group in the plurality of time periods and the resource amount data of each of the plurality of cluster nodes in the plurality of time periods includes the following steps.

Step S1110: Determine whether the estimated resource consumption data of the target container group in each time period is less than or equal to a resource headroom of the cluster node in the time period.

Step S1110 is performed for each of the plurality of cluster nodes.

If a determining result of step S1110 is that the estimated resource consumption data of the target container group in each time period is less than or equal to the resource headroom of the cluster node in the time period, the following step S1120 is performed; or if the determining result of step S1110 is that not all of the estimated resource consumption data of the target container group the time periods is less than or equal to the resource headrooms of the cluster node in the time periods, the following step S1130 is performed.

Step S1120: Determine that the cluster node satisfies a resource amount need of the target container group.

Step S1130: Determine that the cluster node does not satisfy the resource amount need of the target container group.

Specifically, the resource amount data includes a resource headroom. The resource headroom is an amount of resources of the cluster node remaining (that is, available) in each of the plurality of time periods. If the estimated resource consumption data of the target container group in each time period is less than or equal to the resource headroom of the cluster node in the time period, it indicates that the resource headroom of the cluster node in each time period can satisfy the resource amount need of the target container group.

Step S1140: Schedule the target container group to at least one of cluster nodes that satisfy the resource amount need of the target container group.

Specifically, whether each of the plurality of cluster nodes satisfies the resource amount need of the target container group can be determined to select, from the plurality of cluster nodes, at least one cluster node that satisfies the resource amount need of the target container group. All of the at least one cluster node are cluster nodes that satisfy the resource amount need of the target container group, and therefore, the target container group can be scheduled to the at least one cluster node or any one of the at least one cluster node.

The estimated resource consumption data of the target container group in each time period can be compared with the resource headroom of the cluster node in the time period to select a cluster node that satisfies the resource amount need of the target container group. The calculation method is simple and has high efficiency.

With reference to FIG. 12, the following uses an example to describe how to obtain the estimated resource consumption data of the target container group in the plurality of time periods.

FIG. 12 is a schematic flowchart illustrating a resource scheduling method, according to other embodiments of this specification. As shown in FIG. 12, the step of determining estimated resource consumption data of a target container group in a plurality of time periods in response to a resource application request of the target container group includes the following steps.

Step S1210: Obtain historical resource consumption data of the target container group.

Specifically, the historical resource consumption data of the target container group can be obtained by the resource scheduling system from a system for storing an application profile. The application profile is description of traffic and resource usage features of an application during running of the application container group. For example, the application profile of the target container group can include traffic and resource usage data of the target container group in different time periods or at different time nodes.

Step S1220: Determine the estimated resource consumption data of the target container group in the plurality of time periods based on the historical resource consumption data.

Specifically, the determining the estimated resource consumption data of the target container group in the plurality of time periods based on the historical resource consumption data can be: parsing the historical resource consumption data, and extracting the estimated resource consumption data of the target container group in the plurality of time periods from data obtained through parsing.

Because the historical resource consumption data of the target container group can represent estimated resource consumption data of the target container group in a plurality of future time periods, when the estimated resource consumption data of the target container group in the plurality of time periods is determined based on the historical resource consumption data, accuracy of the estimated resource consumption data is improved, which provides an accurate data basis for subsequent resource scheduling.

The following uses an example to describe a case in which the estimated resource consumption data of the target container group in the plurality of time periods needs to be obtained.

In one or more embodiments of this specification, the obtaining historical resource consumption data of the target container group includes: determining whether the target container group agrees to use time-based resources; and if a determining result is that the target container group agrees to use the time-based resources, obtaining the historical resource consumption data of the target container group. The time-based resources are resources used by a plurality of target container groups in turn based on time division. Determining whether the target container group agrees to use the time-based resources is determining whether the target container group uses the resource scheduling method in this specification.

Specifically, if the target container group uses the time-based resources, it indicates that the target container group agrees to use the resource scheduling method in this specification, and therefore, the next step of obtaining the historical resource consumption data of the target container group can continue to be performed. If the target container group does not use the time-based resources, it indicates that the target container group does not use the resource scheduling method in this specification, and therefore, the next step of obtaining the historical resource consumption data of the target container group does not need to continue to be performed. If the target container group does not use the time-based resources, a method for applying for a needed resource amount based on peak resources used by the target container group during running can be used, or another resource scheduling method can be used. Implementations are not specifically limited in this specification.

Whether the target container group agrees to use the time-based resources is determined to provide a plurality of selections for the target container group, thereby improving compatibility of the resource scheduling method in this specification.

The following uses an example to describe how to specifically obtain the historical resource consumption data of the target container group.

In one or more embodiments of this specification, the step of obtaining historical resource consumption data of the target container group includes: extracting a time-based resource consumption feature and/or resource usage configuration data of the target container group; determining, based on the time-based resource consumption feature and/or the resource usage configuration data of the target container group, whether the target container group can use time-based resources; and if a determining result is that the target container group can use the time-based resources, obtaining the historical resource consumption data of the target container group in the plurality of time periods.

Specifically, the time-based resource consumption feature is used to represent resource consumption amounts of the target container group in different time segments or at different time points. The resource usage configuration data is data configured by a target user to which the target container group belongs and to indicate whether to agree to use the time-based resources. The target user can choose whether to agree to use the time-based resources based on an actual application need.

For example, if it is learned, based on the time-based resource consumption feature of the target container group, that a large difference exists between the resource consumption amounts of the target container group in different time segments or at different time nodes, the target container group can use the time-based resources; or if it is learned, based on the time-based resource consumption feature of the target container group, that a small difference or even no difference exists between the resource consumption amounts of the target container group in different time segments or at different time nodes, the target container group does not need to use the time-based resources.

For example, if the resource usage configuration data of the target container group is data indicating agreeing to use the time-based resources, the target container group can use the time-based resources; or if the resource usage configuration data of the target container group is data indicating not agreeing to use the time-based resources, the target container group does not use the time-based resources.

This implementation provides two methos for determining whether the target container group uses the time-based resources. Automatic determining can be implemented not only by using the time-based resource consumption feature of the target container group, but also by using the resource usage configuration data configured by the target user, thereby improving universality of application of the resource scheduling method in this specification.

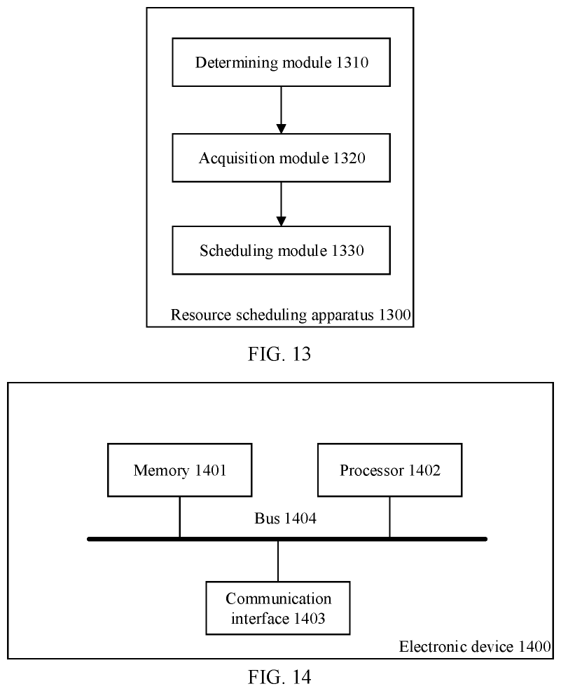

The method embodiments of this specification are described in detail above with reference to FIG. 6 to FIG. 12, and an apparatus embodiment of this specification is described in detail below with reference to FIG. 13. In addition, it should be understood that the description of the method embodiment corresponds to the description of the apparatus embodiment. Therefore, for a part not described in detail, references can be made to the previous method embodiment.

FIG. 13 is a schematic diagram illustrating a structure of a resource scheduling apparatus, according to one or more embodiments of this specification. As shown in FIG. 13, the resource scheduling apparatus 1300 provided in this embodiment of this specification includes a determining module 1310, an acquisition module 1320, and a scheduling module 1330.

Specifically, the determining module 1310 is configured to determine estimated resource consumption data of a target container group in a plurality of time periods in response to a resource application request of the target container group; the acquisition module 1320 is configured to obtain resource amount data of each of a plurality of cluster nodes in the plurality of time periods, where the resource amount data can represent a resource headroom of the cluster node; and the scheduling module 1330 is configured to schedule the target container group to at least one of the plurality of cluster nodes based on the estimated resource consumption data of the target container group in the plurality of time periods and the resource amount data of each of the plurality of cluster nodes in the plurality of time periods.

In some embodiments, the resource amount data includes a first resource occupation amount and a total resource amount. The scheduling module 1330 is further configured to: for each of the plurality of cluster nodes, add the estimated resource consumption data of the target container group in the plurality of time periods to first resource occupation amounts of the cluster node in the plurality of time periods, to obtain second resource occupation amounts of the cluster node in the plurality of time periods; and schedule the target container group to at least one of the plurality of cluster nodes based on the second resource occupation amounts of each of the plurality of cluster nodes in the plurality of time periods and total resource amounts of each of the plurality of cluster nodes in the plurality of time periods.

In some embodiments, the scheduling module 1330 is further configured to: for each of the plurality of cluster nodes, if the second resource occupation amount of the cluster node in each time period is less than or equal to the total resource amount of the cluster node in the time period, determine that the cluster node satisfies a resource amount need of the target container group; and schedule the target container group to at least one of cluster nodes that satisfy the resource amount need of the target container group.

In some embodiments, the scheduling module 1330 is further configured to determine, for each of the cluster nodes that satisfy the resource amount need of the target container group, a maximum estimated resource consumption amount in the estimated resource consumption data of the target container group in the plurality of time periods; add the maximum estimated resource consumption amount to the first resource occupation amounts of the cluster node in the plurality of time periods, to obtain maximum resource occupation amounts of the cluster node in the plurality of time periods; determine time-based benefits corresponding to the cluster node based on the maximum resource occupation amounts of the cluster node in the plurality of time periods and the second resource occupation amounts of the cluster node in the plurality of time periods, where the time-based benefit is used to represent resources saved in the second resource occupation amount relative to the maximum resource occupation amount; and schedule the target container group to at least one of the cluster nodes that satisfy the resource amount need of the target container group based on time-based benefits respectively corresponding to the cluster nodes that satisfy the resource amount need of the target container group.

In some embodiments, the scheduling module 1330 is further configured to determine, based on the time-based benefits respectively corresponding to the cluster nodes that satisfy the resource amount need of the target container group, a cluster node with a maximum time-based benefit in the cluster nodes that satisfy the resource amount need of the target container group; and schedule the target container group to the cluster node with the maximum time-based benefit.

In some embodiments, the scheduling module 1330 is further configured to calculate node benefits respectively corresponding to the cluster nodes that satisfy the resource amount need of the target container group, where the node benefit is used to represent a resource headroom of the cluster node; determine, based on the node benefits and the time-based benefits respectively corresponding to the cluster nodes that satisfy the resource amount need of the target container group, total benefits respectively corresponding to the cluster nodes that satisfy the resource amount need of the target container group; and schedule the target container group to a cluster node with a maximum total benefit in the cluster nodes that satisfy the resource amount need of the target container group.

In some embodiments, the resource amount data includes a resource headroom. The scheduling module 1330 is further configured to: for each of the plurality of cluster nodes, if the estimated resource consumption data of the target container group in each time period is less than or equal to the resource headroom of the cluster node in the time period, determine that the cluster node satisfies a resource amount need of the target container group; and schedule the target container group to at least one of cluster nodes that satisfy the resource amount need of the target container group.

In some embodiments, the determining module 1310 is further configured to obtain historical resource consumption data of the target container group, and determine the estimated resource consumption data of the target container group in the plurality of time periods based on the historical resource consumption data.

In some embodiments, the determining module 1310 is further configured to extract a time-based resource consumption feature and/or resource usage configuration data of the target container group, and obtain the historical resource consumption data of the target container group in the plurality of time periods when determining, based on the time-based resource consumption feature and/or the resource usage configuration data, that the target container group can use time-based resources.

FIG. 14 is a schematic diagram illustrating a structure of an electronic device, according to one or more embodiments of this specification. The electronic device 1400 (which can be a computer device) shown in FIG. 14 includes a memory 1401, a processor 1402, a communication interface 1403, and a bus 1404. The memory 1401, the processor 1402, and the communication interface 1403 are communicatively connected to each other by using the bus 1404.

The memory 1401 can be a read-only memory (ROM), a static storage device, a dynamic storage device, or a random access memory (RAM). The memory 1401 can store a program. When the program stored in the memory 1401 is executed by the processor 1402, the processor 1402 and the communication interface 1403 are configured to execute the steps in the related methods in the embodiments of this specification.

The processor 1402 can be a general-purpose central processing (CPU), a microprocessor, an application-specific integrated circuit (ASIC), graphics processing unit (GPU), or one or more integrated circuits, and is configured to execute a related program to implement functions that need to be performed by the units in the related apparatus in the embodiments of this specification.

The processor 1402 can alternatively be an integrated circuit chip with a signal processing capability. In an implementation process, the steps of the related methods in this specification can be completed by using an integrated logic circuit of hardware in the processor 1402 or instructions in a form of software. The processor 1402 can alternatively be a general-purpose processor, a digital signal processor (DSP), an application-specific integrated circuit (ASIC), a field programmable gate array (FPGA) or another programmable logic device, a discrete gate or transistor logic device, or a discrete hardware component, and can implement or perform the methods, steps, and logical block diagrams disclosed in the embodiments of this specification. The general-purpose processor can be a microprocessor, or the processor can be any conventional processor, etc. The steps of the methods disclosed with reference to the embodiments of this specification can be directly performed by a hardware decoding processor or performed by a combination of hardware and software modules in a decoding processor. The software module can be located in a mature storage medium in the art, for example, a random access memory, a flash memory, a read-only memory, a programmable read-only memory or an electrically erasable programmable memory, or a register. The storage medium is located in the memory 1401. The processor 1402 reads information in the memory 1401, completes, with reference to the hardware in the processor 1402, functions that need to be performed by the units included in the related apparatus in the embodiments of this specification, or performs the related methods in the embodiments of this specification.

The communication interface 1403 implements communication between the electronic device 1400 and another device or a communication network by using a transceiver apparatus such as but not limited to a transceiver. For example, resource scheduling data can be obtained by using the communication interface 1403.

The bus 1404 can include a path for transmitting information between the components (for example, the memory 1401, the processor 1402, and the communication interface 1403) of the electronic device 1400.

It is worthwhile to note that, although the electronic device 1400 shown in FIG. 14 shows only a memory, a processor, and a communication interface, in a specific implementation process, a person skilled in the art should understand that the electronic device 1400 further includes another component needed to implement normal operation. In addition, based on a specific need, a person skilled in the art should understand that the electronic device 1400 can further include a hardware component that implements another additional function. In addition, a person skilled in the art should understand that the electronic device 1400 can include only components needed to implement the embodiments of this specification, and does not need to include all the components shown in FIG. 14.

A person of ordinary skill in the art can be aware that, the units and the algorithm steps in the examples described with reference to the embodiments disclosed in this specification can be implemented by electronic hardware or a combination of computer software and electronic hardware. Whether the functions are performed by hardware or software depends on particular applications and design constraint conditions of the technical solutions. A skilled person can use different methods to implement the described functions for each particular application, but this implementation should not be considered as beyond the scope of this specification.

It can be clearly understood by a person skilled in the art that, for convenience and brevity of description, for specific working processes of the previously described apparatus and module, references can be made to corresponding processes in the previous method embodiments, and details are omitted here for simplicity.

In the several embodiments provided in this specification, it should be understood that the disclosed apparatus and method can be implemented in other ways. For example, the described apparatus embodiment is merely an example. For example, the unit division is merely logical function division, and there may be other division methods in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electrical, mechanical, or other forms.

The units described as separate parts may or may not be physically separated, and parts displayed as units may or may not be physical units, that is, may be located in one place or may be distributed on a plurality of network units. Some or all of the units can be selected based on an actual demand to implement the objectives of the solutions of the embodiments.

In addition, the functional units in the embodiments of this specification may be integrated into one processing unit, or each of the units may exist alone physically, or two or more of the units may be integrated into one unit.

When the function is implemented in a form of a software functional unit and sold or used as an independent product, the function can be stored in a computer-readable storage medium. Based on such an understanding, the technical solutions in this specification essentially or the part contributing to the existing technologies or a part of the technical solutions can be embodied in a form of a software product. The computer software product is stored in a storage medium, and includes several instructions for enabling a computer device (which can be a personal computer, a server, a network device, etc.) to perform all or some of the steps in the methods in the embodiments of this specification. The previous storage medium includes any medium that can store program code, such as a USB flash drive, a removable hard disk, a read-only memory, a random access memory, a magnetic disk, or an optical disc.

The previous descriptions are merely specific implementations of this specification, but are not intended to limit the protection scope of this specification. Any variation or replacement readily figured out by a person skilled in the art within the technical scope disclosed in this specification shall fall within the protection scope of this specification. Therefore, the protection scope of this specification shall be subject to the protection scope of the claims.

What is claimed is:

1. A resource scheduling method, comprising:
determining estimated resource consumption data of a target container group in a plurality of time periods in response to a resource application request of the target container group;
obtaining resource amount data of each of a plurality of cluster nodes in the plurality of time periods, wherein the resource amount data can represent a resource headroom of the cluster node; and
scheduling the target container group to at least one of the plurality of cluster nodes based on the estimated resource consumption data of the target container group in the plurality of time periods and the resource amount data of each of the plurality of cluster nodes in the plurality of time periods.

2. The method according to claim 1, wherein the resource amount data comprises a first resource occupation amount and a total resource amount, and the scheduling the target container group to at least one of the plurality of cluster nodes based on the estimated resource consumption data of the target container group in the plurality of time periods and the resource amount data of each of the plurality of cluster nodes in the plurality of time periods comprises:
for each of the plurality of cluster nodes, adding the estimated resource consumption data of the target container group in the plurality of time periods to first resource occupation amounts of the cluster node in the plurality of time periods, to obtain second resource occupation amounts of the cluster node in the plurality of time periods; and
scheduling the target container group to at least one of the plurality of cluster nodes based on the second resource occupation amounts of each of the plurality of cluster nodes in the plurality of time periods and total resource amounts of each of the plurality of cluster nodes in the plurality of time periods.

3. The method according to claim 2, wherein the scheduling the target container group to at least one of the plurality of cluster nodes based on the second resource occupation amounts of each of the plurality of cluster nodes in the plurality of time periods and total resource amounts of each of the plurality of cluster nodes in the plurality of time periods comprises:
for each of the plurality of cluster nodes, if the second resource occupation amount of the cluster node in each time period is less than or equal to the total resource amount of the cluster node in the time period, determining that the cluster node satisfies a resource amount need of the target container group; and
scheduling the target container group to at least one of cluster nodes that satisfy the resource amount need of the target container group.

4. The method according to claim 3, wherein the scheduling the target container group to at least one of cluster nodes that satisfy the resource amount need of the target container group comprises:
determining, for each of the cluster nodes that satisfy the resource amount need of the target container group, a maximum estimated resource consumption amount in the estimated resource consumption data of the target container group in the plurality of time periods;
adding the maximum estimated resource consumption amount to the first resource occupation amounts of the cluster node in the plurality of time periods, to obtain maximum resource occupation amounts of the cluster node in the plurality of time periods;
determining time-based benefits corresponding to the cluster node based on the maximum resource occupation amounts of the cluster node in the plurality of time periods and the second resource occupation amounts of the cluster node in the plurality of time periods, wherein the time-based benefit is used to represent resources saved in the second resource occupation amount relative to the maximum resource occupation amount; and
scheduling the target container group to at least one of the cluster nodes that satisfy the resource amount need of the target container group based on time-based benefits respectively corresponding to the cluster nodes that satisfy the resource amount need of the target container group.

5. The method according to claim 4, wherein the scheduling the target container group to at least one of the cluster nodes that satisfy the resource amount need of the target container group based on time-based benefits respectively corresponding to the cluster nodes that satisfy the resource amount need of the target container group comprises:
determining, based on the time-based benefits respectively corresponding to the cluster nodes that satisfy the resource amount need of the target container group, a cluster node with a maximum time-based benefit in the cluster nodes that satisfy the resource amount need of the target container group; and
scheduling the target container group to the cluster node with the maximum time-based benefit.

6. The method according to claim 4, wherein the scheduling the target container group to at least one of the cluster nodes that satisfy the resource amount need of the target container group based on time-based benefits respectively corresponding to the cluster nodes that satisfy the resource amount need of the target container group comprises:
calculating node benefits respectively corresponding to the cluster nodes that satisfy the resource amount need of the target container group, wherein the node benefit is used to represent a resource headroom of the cluster node;
determining, based on the node benefits and the time-based benefits respectively corresponding to the cluster nodes that satisfy the resource amount need of the target container group, total benefits respectively corresponding to the cluster nodes that satisfy the resource amount need of the target container group; and
scheduling the target container group to a cluster node with a maximum total benefit in the cluster nodes that satisfy the resource amount need of the target container group.

7. The method according to claim 1, wherein the resource amount data comprises a resource headroom, and the scheduling the target container group to at least one of the plurality of cluster nodes based on the estimated resource consumption data of the target container group in the plurality of time periods and the resource amount data of each of the plurality of cluster nodes in the plurality of time periods comprises:
for each of the plurality of cluster nodes, if the estimated resource consumption data of the target container group in each time period is less than or equal to the resource headroom of the cluster node in the time period, determining that the cluster node satisfies a resource amount need of the target container group; and
scheduling the target container group to at least one of cluster nodes that satisfy the resource amount need of the target container group.

8. The method according to claim 1, wherein the determining estimated resource consumption data of a target container group in a plurality of time periods comprises:
obtaining historical resource consumption data of the target container group; and
determining the estimated resource consumption data of the target container group in the plurality of time periods based on the historical resource consumption data.

9. The method according to claim 8, wherein the obtaining historical resource consumption data of the target container group comprises:
extracting a time-based resource consumption feature and/or resource usage configuration data of the target container group; and
obtaining the historical resource consumption data of the target container group in the plurality of time periods when determining, based on the time-based resource consumption feature and/or the resource usage configuration data, that the target container group can use time-based resources.

10. The method according to claim 1, wherein the target container group comprises a plurality of application containers, and peaks and valleys of the estimated resource consumption data of the plurality of application containers in the plurality of time periods are complementary to each other.

11. An electronic device, comprising a memory and a processor, wherein the memory stores executable instructions that, in response to execution by the processor, cause the processor to:
determine estimated resource consumption data of a target container group in a plurality of time periods in response to a resource application request of the target container group;
obtain resource amount data of each of a plurality of cluster nodes in the plurality of time periods, wherein the resource amount data can represent a resource headroom of the cluster node; and
schedule the target container group to at least one of the plurality of cluster nodes based on the estimated resource consumption data of the target container group in the plurality of time periods and the resource amount data of each of the plurality of cluster nodes in the plurality of time periods.

12. A non-transitory computer-readable storage medium comprising instructions stored therein that, when executed by a processor of an electronic device, cause the processor to:
determine estimated resource consumption data of a target container group in a plurality of time periods in response to a resource application request of the target container group;
obtain resource amount data of each of a plurality of cluster nodes in the plurality of time periods, wherein the resource amount data can represent a resource headroom of the cluster node; and
schedule the target container group to at least one of the plurality of cluster nodes based on the estimated resource consumption data of the target container group in the plurality of time periods and the resource amount data of each of the plurality of cluster nodes in the plurality of time periods.
